(19) United States
(12) Patent Application Publication
(10) Pub. No.: US 2026/0332887 A1
(43) Pub. Date: Oct. 22, 2026

(54) REMOTE CAMERA CONTROL VIA GAZE DETECTION

(71) Applicant: LENOVO (BEIJING) LIMITED, Beijing (CN)

(72) Inventors: Xiang Feng, Jiading District (CN); Koichiro Ishigami, Kawasaki-shi (JP); Sean C. Kelly, Wake Forest, NC (US)

(21) Appl. No.: 19/119,364

(22) PCT Filed: Oct. 8, 2023
(86) PCT No.: PCT/CN2023/123363

§ 371 Date: Apr. 8, 2025

(51) Int. Cl. H04N 23/66; H04N 23/611; H04N 23/695

(52) U.S. Cl. CPC H04N 23/66; H04N 23/611; H04N 23/695

(57) ABSTRACT

An apparatus and system for camera control of remote cameras. An apparatus can include a display device. The apparatus can further include a first camera mounted to the display device. The first camera can capture an image of an iris of a user of the display device. The apparatus can include processing circuitry coupled to the first camera. The processing circuitry can detect a gaze direction of the iris based on the image. The processing circuitry can encode a control signal to control a position of a second camera remote from the first camera based on the gaze direction.

### TECHNICAL FIELD

Embodiments described herein generally relate to camera systems for video conferencing, and in an embodiment, but not by way of limitation, remote camera control during videoconferencing.

### BACKGROUND

During video conference calls, remote participants may wish to control the camera at the main video conference location. Some systems may rely on audio input or other criteria to zoom in or focus on the current speaker or other elements in the video conference. However, remote participants may prefer to zoom in on other areas of the remote conference room, or on documents or other visual aids within the conference room.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings,

FIG. 1 illustrates an apparatus for remote camera-based pan and tilt control via gaze detection according to some embodiments.

FIG. 2 illustrates a system for remote camera-based pan and tilt control via gaze detection according to some embodiments.

FIG. 3 illustrates camera types for use in a system for remote camera-based pan and tilt control via gaze detection according to some embodiments.

FIG. 4 is a flowchart of a method for remote camera-based pan and tilt control via gaze detection according to some embodiments.

FIG. 5 provides a detailed overview of example components within a computing device in a computing system.

### DETAILED DESCRIPTION

Video conferencing has become increasingly popular recently due to declining costs of conferencing equipment and the proliferation of high-speed Internet. Typically, business organizations will designate a physical space dedicated to video conferencing. Conference attendees can join the conference locally or remotely. There may multiple different speakers present locally and remotely, and other visual aids such as whiteboards, prototype products, etc. may be in use.

The designed physical space can include at least one camera positioned to capture a video stream of all or a portion of the designated conferencing environment, including the local attendees, visual aids, etc. Some systems can detect activity within the physical space and adjust the boundaries of an image (field-of-view) displayed to a remote conference participant accordingly. For example, some systems can detect people or objects within a larger physical space and reframe (or “zoom”) the captured video stream around the people/objects. Typically, once the camera has been framed or zoomed, further camera control is not undertaken. For example, the camera/s in use may remain focused on the front of the designated conferencing environment.

However, remote participants may wish to zoom in on different people or scenes at various times throughout the video conference. Users may also be interested in particular details of the video conference. For example, a remote participant may wish to see facial expressions of various people in the room or focus in on a prototype product being demonstrated. Methods exist that assess scene content saliency and zoom/crop automatically, but this may not represent a remote participant's desired view area in the remote location.

Methods and apparatuses according to embodiments of this disclosure address these concerns by combining gaze detection (which determines an observer's view angle and region of interest in an image) with control of the remote camera (e.g., the camera/s present in the remote conferencing environment) based on the observer's gaze. Methods and apparatuses can allow an observer to view content of interest in high resolution or based on other customized needs or preferences of the observer.

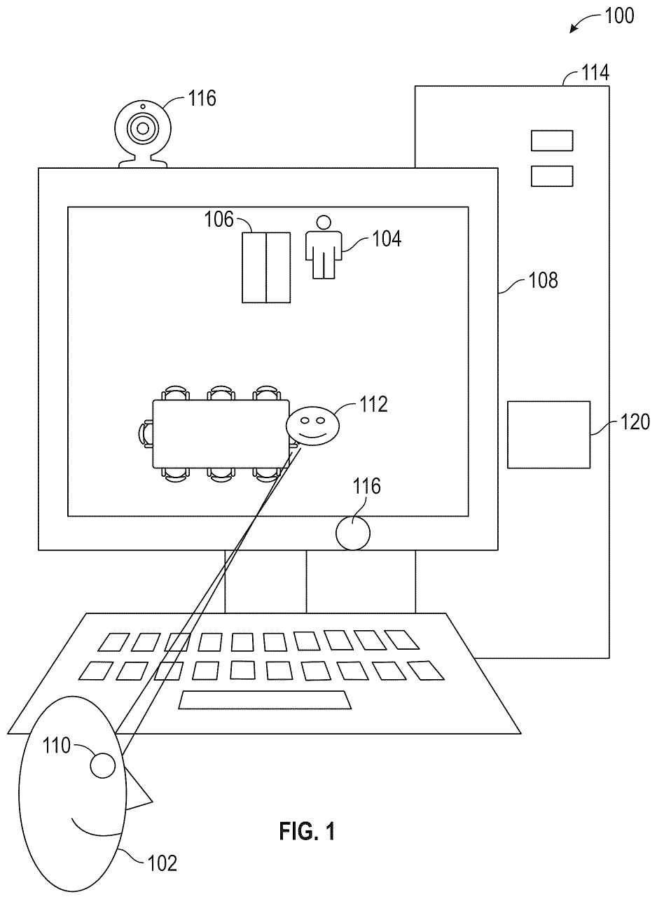

FIG. 1 illustrates an apparatus 100 for remote camera-based pan and tilt control via gaze detection according to some embodiments. As seen in FIG. 1, a remote user 102 may be participating in a video conference using a display device 108. The display device 108 displays a user interface including one or more interface elements to the user 102. In the example, the user interface includes video conferencing elements including a presenter 104 speaking at a whiteboard 106. The user's computer 114 can include a camera 116 mounted thereto. Other camera/s 116 can be included elsewhere on the display device 108.

The user iris 110 can be focused on various locations on the display device 108. For example, the remote user's iris 110 may focus on spot 112. The remote user 102 may be looking at spot 112 to detect a facial expression of the person at spot 112, for example, or because some other point of interest is included at spot 112. Processing circuitry 120 can use image/s of the iris 110 of the user 102, captured by the camera/s 116, to determine the gaze direction of the remote user 102. For example, based on known coordinates of elements on the display device 108, the processing circuitry 120 can use the detected gaze of the user 102 to determine which elements the user 102 is focusing on, by electronically analyzing the location of user elements within the user interface relative to the user 102 gaze location.

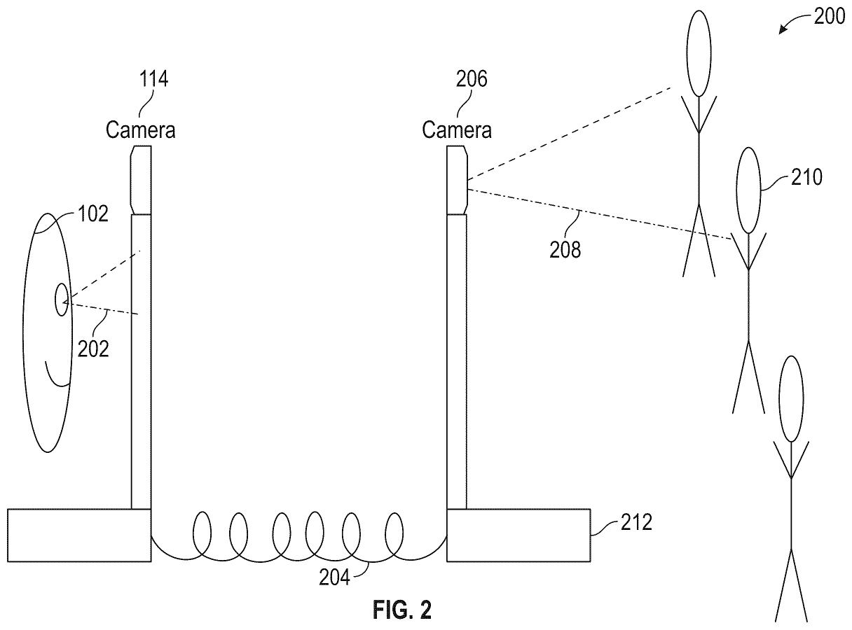

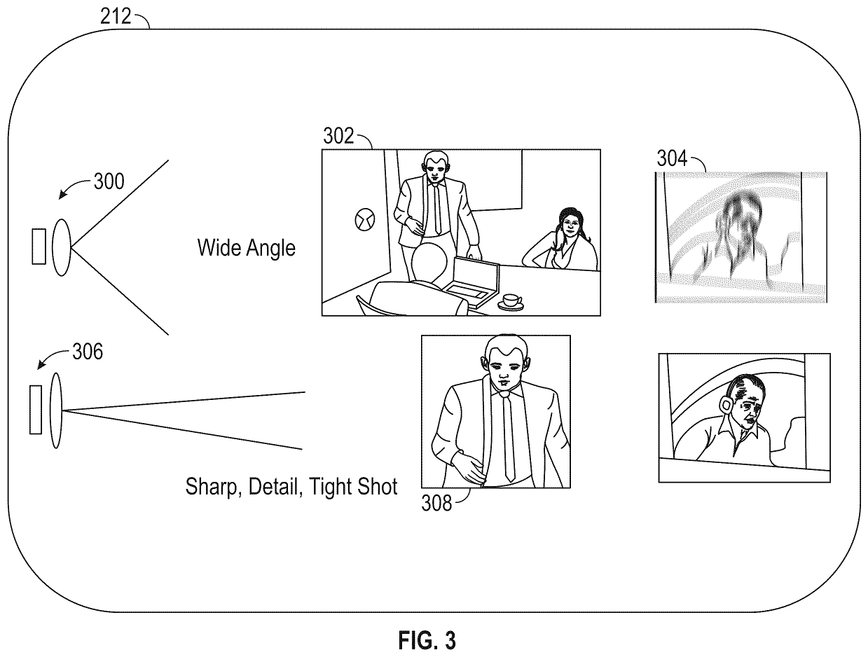

As mentioned earlier herein, some available systems can zoom in on the presenter 104 or crop out a portion of the video to focus on the presenter 104 or other pre-determined position. However, methods according to embodiments provide a way for gaze detection, based on the gaze direction of the remote user 102, to guide a remote camera system to focus on content of relevance to the remote user 102. For example, the processing circuitry 120 can encode a control signal to control a position of a second camera remote from the first camera based on the gaze direction, as described with respect to FIG. 2 and FIG. 3.

FIG. 2 illustrates a system 200 for remote camera-based pan and tilt control via gaze detection according to some embodiments. Based on the detected gaze direction 202, the processing circuitry 120 (FIG. 1) can encode a control signal 204 to be transmitted to control a position of a second camera 206 remote from the first camera 116. The control signal 204 can include metadata or other data appended to a signal for controlling the camera 206. The control signal 204 can include data or a control signal to control at least one of a pan function, a tilt function, and a crop function of the second camera 206.

Focus 208 can be provided at the remote location using the second camera 206 to match or align to the gaze direction 202 of the user 102. For example, if the user 102 is looking down as shown at gaze direction 202, the camera 206 can be controlled to focus down as shown at focus 208. In the illustrated example, the user 102 may be focused on person 210 at the remote location 212 (e.g., the remote videoconferencing room).

More than one camera can be provided at the remote location 212. FIG. 3 illustrates camera types for use in a system for remote camera-based pan and tilt control via gaze detection according to some embodiments. For example, a wide angle (or wide field of view (WFoV) camera) 300 can be provided at the remote location 212. The wide-angle camera 300 can be used to crop an area of interest 302. While wide angle cameras 300 can be useful in some situations, blurring can result as seen at view 304. In some examples, a telephoto lens or other high-resolution camera 306 can be provided to show high resolution detail of an area of interest 308. Focusing on the area of interest 308 may be accomplished with reduced blurring using the higher-resolution (e.g., telephoto) camera 306. The processing circuitry 120 (FIG. 1) can encode a second control signal (or provide additional data in the first control signal) to control a position of both or each of the cameras 300, 306.

Referring again to FIG. 1, a group of set of remote users 102 can be viewing a video conference, each on a separate display (not shown in FIG. 1) or each at the same display device 108. Respective processing circuitry 120 of each user device can access respective camera/s 116 to detect gaze directions of two or more of these users 102. The processing circuitry 120 can determine priority levels for the plurality of users and encode the control signal based on a highest priority group of users in some embodiments. In other embodiments, other methods can be used to control the remote cameras, such as by polling or surveys. In examples, processing circuitry 120 can encode control signals based on a determination of user preferences of a largest number of users (or of a more senior person, or other criteria).

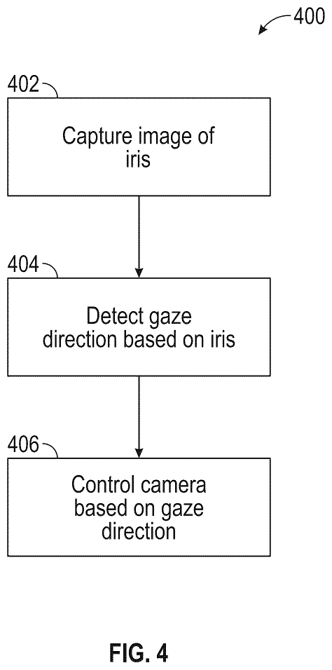

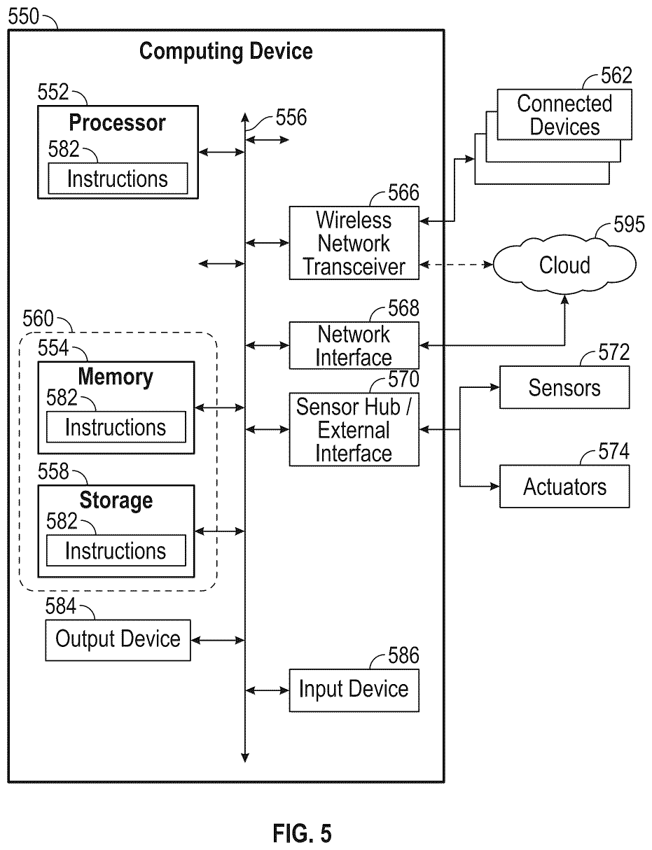

FIG. 4 is a flowchart of a method 400 for remote camera-based pan and tilt control via gaze detection according to some embodiments. The method 400 can be implemented by processing circuitry 120 (FIG. 1) camera/s 116 (FIG. 1) or other components shown in FIG. 1 or FIG. 5.

The method 400 can begin with operation 402 with a camera 116 capturing an image of an iris 110 of a user 102 of a display device 108.

The method 400 can continue with operation 404 with the processing circuitry 120 detecting a gaze direction of the iris 110 based on the image captured in operation 402.

The method 400 can continue with operation 406 with the processing circuitry 120 encoding a control signal to control a position of a camera remote from the display device based on the gaze direction (e.g., camera 206 (FIG. 2), or camera 300 or camera 306 (FIG. 3)). The control signal can include data to control at least one of a pan function, a tilt function, and a crop function of the camera. Multiple control signals can be encoded to control multiple remote cameras. Alternatively, a single control signal can be encoded with multiple data portions to control multiple remote cameras.

FIG. 5 provides a detailed overview of example components within a computing device 550 in a computing system. Computing device 550 may be embodied as a type of device, appliance, computer, or other “thing” capable of communicating with other Edge, networking, or endpoint components. For example, a computing device 550 may be embodied as a personal computer, server, smartphone, a mobile computing device, a smart appliance, an in-vehicle compute system (e.g., a navigation system), a self-contained device having an outer case, shell, etc., or other device or system capable of performing the described functions. The computing device 550 can perform operations for video conferencing and can be same or similar to the computer 114 (FIG. 1). In examples, the computing device 550 (or components thereof such as camera/s and communication circuitry) may be a device provided at the remote video conferencing location.

This computing device 550 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing device 550, or as components otherwise incorporated within a chassis of a larger system.

The instructions 582 on the processor 552 (separately, or in combination with the instructions 582 of the machine readable medium 560) may configure execution or operation of a videoconferencing system, apparatus or method. For example, a video conference can be executed on a display of the device 550, and cameras or other input devices can be used to detect gaze direction of a user, relative to display coordinates of videoconference elements.

The computing device 550 described above can include other components for performing operations in accordance with example embodiments. The computing device 550 may include processing circuitry in the form of a processor 552, which may be a microprocessor, a multi-core processor, a multithreaded processor, an ultra-low voltage processor, an embedded processor, an xPU/DPU/IPU/NPU, special purpose processing unit, specialized processing unit, or other known processing elements.

The processor 552 may communicate with a system memory 554 over an interconnect 556 (e.g., a bus). Any number of memory devices may be used to provide for a given amount of system memory. To provide for persistent storage of information such as data, applications, operating systems and so forth, a storage 558 may also couple to the processor 552 via the interconnect 556. The components may communicate over the interconnect 556. The interconnect 556 may include any number of technologies, including industry standard architecture (ISA), extended ISA (EISA), peripheral component interconnect (PCI), peripheral component interconnect extended (PCIx), PCI express (PCIe), or any number of other technologies.

The interconnect 556 may couple the processor 552 to a transceiver 566, for communications with the connected Edge devices 562 or with cameras or computer equipment at a remote videoconference location as described earlier herein. The transceiver 566 may use any number of frequencies and protocols. The wireless network transceiver 566 (or multiple transceivers) may communicate using multiple standards or radios for communications at a different range. For example, the computing device 550 may communicate with close devices, e.g., within about 10 meters, using a local transceiver based on Bluetooth Low Energy (BLE), or another low power radio, to save power. More distant connected Edge devices 562, e.g., within about 50 meters, may be reached over ZigBee® or other intermediate power radios.

A wireless network transceiver 566 (e.g., a radio transceiver) may be included to communicate with devices or services in a cloud (e.g., an Edge cloud 595) via local or wide area network protocols. Given the variety of types of applicable communications from the device to another component or network, applicable communications circuitry used by the device may include or be embodied by any one or more of components 564, 566, 568, or 570. Accordingly, in various examples, applicable means for communicating (e.g., receiving, transmitting, etc.) may be embodied by such communications circuitry.

Sensors 572 can include cameras and other imaging systems for use as described above for detecting gaze and for use in a remote location. Actuators can include motor controls or other controls to move, tilt, pan, or perform other movements on cameras or other sensors.

Output device 584 can include displays (to, for example request user input or display other information concerning applications described herein), and input device 586 can include keyboards, mice, etc. for receiving user input.

In an example, the instructions 582 provided via the memory 554, the storage 558, or the processor 552 may be embodied as a non-transitory, machine-readable medium 560 including code to direct the processor 552 to perform electronic operations in the computing device 550. The processor 552 may access the non-transitory, machine-readable medium 560 over the interconnect 556. For instance, the non-transitory, machine-readable medium 560 may be embodied by devices described for the storage 558 or may include specific storage units such as storage devices and/or storage disks that include optical disks (e.g., digital versatile disk (DVD), compact disk (CD), CD-ROM, Blu-ray disk), flash drives, floppy disks, hard drives (e. g., SSDs), or any number of other hardware devices in which information is stored for any duration (e.g., for extended time periods, permanently, for brief instances, for temporarily buffering, and/or caching). The non-transitory, machine-readable medium 560 may include instructions to direct the processor 552 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

While the illustrated examples of FIG. 5 include example components for a compute node and a computing device, respectively, examples disclosed herein are not limited thereto. As used herein, a “computer” may include some or all of the example components of FIG. 5 in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIG. 5, each of which may include different sub-components, different memory capacities, I/O capabilities, etc. For example, because some implementations of distributed networking and/or distributed computing are associated with particular desired functionality, examples disclosed herein include different combinations of components illustrated in FIG. 5 to satisfy functional objectives of distributed computing tasks. In some examples, one or more objective functions of a distributed computing task(s) rely on one or more alternate devices/structure located in different parts of an Edge networking environment, such as devices to accommodate data storage.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example.

Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An apparatus for camera control, the apparatus comprising:
a display device;
a first camera mounted to the display device, the first camera configured to capture an image of an iris of a user of the display device; and
processing circuitry coupled to the first camera and configured to:
detect a gaze direction of the iris based on the image; and
encode a control signal to control a position of a second camera remote from the first camera based on the gaze direction.

2. The apparatus of claim 1, wherein the control signal includes data to control at least one of a pan function, a tilt function, and a crop function of the second camera.

3. The apparatus of claim 1, wherein the processing circuitry is configured to encode a second control signal to control a position of a third camera of a different type than the second camera.

4. The apparatus of claim 3, wherein the third camera and the second camera include a wide field of view (WFoV) camera and a telephoto camera.

5. The apparatus of claim 1, wherein the processing circuitry is coupled to a plurality of first cameras and wherein the processing circuitry is configured to detect gaze directions of a plurality of users.

6. The apparatus of claim 5, wherein the processing circuitry is configured to determine priority levels for the plurality of users and to encode the control signal based on a highest priority group of users.

7. The apparatus of claim 5, wherein the processing circuitry is configured to provide a request for user input regarding control of the second camera.

8. The apparatus of claim 7, wherein the processing circuitry is configured to encode the control signal based on a determination of user preferences of a largest number of users.

9. A system for camera control, the system comprising:
a display device;
a first camera mounted to the display device, the first camera configured to capture an image of an iris of a user of the display device;
processing circuitry coupled to the first camera, the processing circuitry configured to detect a gaze direction of the iris based on the image; and
a communication interface between the processing circuitry and a second camera, the communication interface configured to provide a control signal from the processing circuitry to the second camera, the control signal encoded based on the gaze direction.

10. The system of claim 9, wherein the second camera includes a wide field of view (WFoV) lens.

11. The system of claim 9, further including a third camera having a telephoto lens.

12. The system of claim 9, wherein the control signal includes data to control at least one of a pan function, a tilt function, and a crop function of the second camera.

13. The system of claim 9, wherein the processing circuitry is coupled to a plurality of first cameras and wherein the processing circuitry is configured to detect gaze directions of a plurality of users.

14. The system of claim 13, wherein the processing circuitry is configured to determine priority levels for the plurality of users and to encode the control signal based on a highest priority group of users.

15. The system of claim 13, wherein the processing circuitry is configured to provide a request for user input regarding control of the second camera and to encode the control signal based on a determination of user preferences of a largest number of users.

16. A method for remote camera control, the method comprising:
capturing an image of an irs of a user of a display device;
detecting a gaze direction of the iris based on the image; and
encoding a control signal to control a position of a camera remote from the display device based on the gaze direction.

17. The method of claim 16, wherein the control signal includes data to control at least one of a pan function, a tilt function, and a crop function of the camera.

18. The method of claim 16, wherein the method includes encoding another control signal to control a position of another camera.

19. The method of claim 16, wherein the method includes detecting gaze directions of a plurality of users.

20. The method of claim 19, wherein the method includes determining priority levels for the plurality of users and encoding the control signal based on a highest priority group of users.
